(19) United States
(12) Patent Application Publication
(10) Pub. No.: US 2025/0058406 A1
(43) Pub. Date: Feb. 20, 2025

(54) Laser Machining a Transparent Workpiece

(71) Applicant: TRELLEBORG SEALING PROFILES GERMANY GMBH, Großheubach (DE)

(72) Inventors: Klaus Bergner, Jena (DE); Stefan Nolte, Jena (DE)

(21) Appl. No.: 18/936,774

(22) Filed: Nov. 4, 2024

Related U.S. Application Data
(63) Continuation of application No. 18/835,717, filed on Jan. 1, 0001.
Application No. 18/835,717 is a continuation of application No. 16/643,641, filed on Mar. 12, 2020, now abandoned.

(30) Foreign Application Priority Data
Sep. 1, 2017 (DE) 102017120187.4
Sep. 13, 2017 (DE) 102017121140.3

(51) Int. Cl. B23K 26/00; B23K 26/03; B23K 26/06; B23K 26/062; B23K 26/0622; B23K 26/064; B23K 26/50; B23K 26/53; B23K 103/00; C03C 15/00; G01N 21/39

(52) U.S. Cl. CPC B23K 26/0006; B23K 26/032; B23K 26/062; B23K 26/0624; B23K 26/064; B23K 26/0665; B23K 26/50; B23K 26/53; C03C 15/00; G01N 21/39; B23K 2103/54; G01N 2201/06113

(57) ABSTRACT

The invention relates to a method for machining a transparent workpiece (4) by generating non-linear absorption of laser radiation in a laser beam focus located in a volume of the workpiece (4). The object of the invention is that of providing a method of improved precision and quality, and a corresponding device, for laser machining of workpieces. In particular, it is also intended for it to be possible for workpieces made of composite materials or of other special materials, such as filter glass, to be machined at an improved level of quality. For this purpose, the method according to the invention comprises the following steps:
spectroscopic measurement of the linear absorption of the laser radiation in the workpiece (4),
selecting a working wavelength at which the linear absorption is low, and
machining the workpiece (4) by means of the application laser radiation at the working wavelength. The invention furthermore relates to a corresponding device for machining a transparent workpiece (4).

### CROSS-REFERENCES TO RELATED APPLICATIONS

This patent application claims benefit of U.S. patent application Ser. No. 18/835,717 filed Aug. 2, 2024, which claims benefit of U.S. patent application Ser. No. 16/643,641 filed Mar. 12, 2020, which is a national stage filing of International Application No. PCT/EP2018/073604 (International Publication No. WO 2019/043220), filed on Sep. 3, 2018, which claims priority to German Patent Application No. 102017121140.3, filed on Sep. 13, 2017, and which also claims priority to German Patent Application No. 102017120187.4, filed on Sep. 1, 2017, the contents of which are hereby incorporated by reference in their entirety.

The invention relates to a method for machining a transparent workpiece by generating non-linear absorption of laser radiation in a laser beam focus located in a volume of the workpiece.

The invention furthermore relates to a device for machining a transparent workpiece.

It is known from the prior art that workpieces made of transparent materials, such as glass or quartz, or also (non-pigmented) body tissue, can be machined in a highly precise manner by means of laser radiation. This is achieved by way of energy deposition by non-linear absorption in a laser beam focus, which can be located not (only) on the surface, but rather at any desired position in the volume of the workpiece. Multi-photon processes arise in the laser beam focus, e.g. in the form of multi-photon ionization or avalanche ionization, which lead to a plasma being formed. The plasma formation rate increases significantly above a threshold that depends on the material of the workpiece and the parameters of the laser radiation. Reference is therefore also made to an “optical penetration”. The modification brought about thereby, and thus machining of the material, is very high-precision, since it is possible to introduce small amounts of energy into the material in a spatially localized and reproducible manner. The good spatial localization is achieved primarily by focusing the laser radiation by means of coupling optics that is as aberration-free as possible and has a large numerical aperture. It is in particular also possible to adjust the position and shape of the energy deposition in a task-specific manner. For this purpose, it is possible for example to use lenses having a small numerical aperture, axicons or combinations thereof, as well as targeted aberrations, in order for example to generate extended focus volumes in the laser propagation direction.

In general, in this type of material machining by means of non-linear absorption, pulsed laser radiation consisting of short or ultrashort laser pulses, at a simultaneously high pulse power, is used. It is thus possible to achieve a low energy input at a high degree of reproducibility. Laser pulses having a pulse duration in the range of from a few femtoseconds to a few picoseconds are particularly advantageous. The pulse energy is generally in the region of a few microjoules, and, for extended focus volumes, in the range of a few 10-100 microjoules or even in the millijoule range.

Laser-based material machining is used in the prior art for example for generating separation planes or predetermined breaking points for the purpose of glass separation, i.e. for separating a plurality of connected glass workpieces. In this case, a uniform modification of the material over the entire thickness of the workpiece plays an important role. As a result, for example the frangibility is facilitated, production errors such as spalling or stress differences are minimized, and high edge strengths are achieved. In this case, the glass materials to be machined are generally transparent over a wide wavelength range of the laser radiation used. However, as soon as special glass (e.g. filter glass) or glass composite materials in which different types of glass are combined, or auxiliary layers (such as films or adhesive) are present in the workpiece, said materials can exhibit significant linear absorption for the laser radiation used. This can impede the desired non-linear interaction or prevent uniform energy deposition over the entire workpiece thickness (in accordance with the Beer-Lambert law).

Against this background, the object of the invention is that of providing a method of improved precision and quality, and a corresponding device, for laser machining of workpieces. In particular, it is also intended for it to be possible for workpieces made of composite materials or of other special materials, such as filter glass, to be machined at an improved level of quality.

The invention achieves this object by means of a method for machining a transparent workpiece by generating non-linear absorption of laser radiation in a laser beam focus located in a volume of the workpiece, said method comprising the following steps:
spectroscopic measurement of the linear absorption of the laser radiation in the workpiece,
selecting a working wavelength at which the linear absorption is low, and
   machining the workpiece by means of application of laser radiation at the working wavelength.

The invention furthermore achieves the object by means of a device for machining a transparent workpiece, comprising:
a laser that emits a laser beam at an adjustable working wavelength,
coupling optics that couples the laser beam into the volume of the workpiece and focusses said beam in a laser beam focus located in the volume of the workpiece,
a measuring device that measures the linear absorption of the laser radiation in the workpiece,
   a controller that is connected to the laser, the measuring device and the coupling optics, which controller is designed to set the working wavelength to a value at which the linear absorption is low, and to vary the position of the laser beam focus during the machining of the workpiece.

According to the invention, prior to the actual machining, a spectroscopic measurement of the workpiece is carried out, in order to identify an ideal
wavelength range for the working wavelength, in which there is minimum, but in any case as little as possible, linear absorption of the laser radiation used.

Suppressing or minimizing the linear absorption makes it possible to achieve a high intensity in the desired interaction range, by means of beam focusing. As a result, largely non-linear absorption occurs only in these ranges. In the case of
corresponding beamforming, this allows for uniform, tailored energy deposition over the entire thickness of the workpiece. Undesired flaws such as stresses, racks, voids, etc. are prevented or distributed over the substate thickness in a uniform or specific manner.

Ideally, the Ideally, the linear absorption in the material of the workpiece should be below 20%, more preferably below 10%, over a length of one centimeter in the laser
beam direction.

The result of the measurement can also be used, when selecting the working wavelength, such that the obtained transmission curve exhibits a maximum at the working wavelength.

Following the measurement, the workpiece is machined in the selected wavelength range.

For this purpose, it is possible for a corresponding laser, for example, to be selected and used, in which the fundamental laser wavelength is in the desired wavelength range. Alternatively, the desired working wavelength can be adjusted accordingly by means of frequency conversion (e.g. generation of the second or a higher harmonic, optical-parametric conversion, frequency mixing, supercontinuum generation, Raman conversion, etc.).

Laser systems that are suitable for the practical implementation of the invention and the wavelength of which can be tuned are commercially available.

When a tunable laser is used, said laser can simultaneously also be used for measuring the linear absorption. In this case, simply the transmission of the laser radiation is measured, for different wavelength settings, and specifically as far as possible without focusing the laser radiation in the volume of the workpiece.

In a preferred embodiment of the method according to the invention, the working wavelength is selected in accordance with the secondary condition that the non-linear absorption should be as high as possible, at the working wavelength. This means, in other words, that the workpiece measurement according to the invention prior to the actual machining can additionally be used for also selecting a particularly suitable wavelength for the non-linear absorption. For this purpose, the working wavelength is expediently set, on the basis of the transmission curve, in such a way that the absorption is minimal at the working wavelength itself, but assumes a higher value at a harmonic of said wavelength (i.e. at a fraction of the working wavelength: e.g. 1/2, 1/3, 1/4, etc.). As a result, selecting the working wavelength accordingly makes it possible for the degree of non-linearity in the absorption to be selected, and thus for the non-linear machining to be adjusted. If for example at a particular working wavelength twelve photons are required for to overcoming a band gap of the material, in order to generate free electrons (ionization), the likelihood of such multi-photon absorption is relatively low. Adjusting the working wavelength, still in the range of low linear absorption of the material of the workpiece, results in a higher likelihood of ionization, if, in the changed working wavelength, for example only six, four or two photons are required for ionization.

The method according to the invention is suitable in particular for separating glass workpieces, wherein the position of the laser focus is guided, during the machining, between two or more connected glass workpieces, along a separation plane or a predetermined breaking point. The glass workpieces may for example be optical filter glass or also motor vehicle (front) windows (e.g. having a light-absorbing tint or laminated intermediate layers), or other special glass in the optics industry. The method according to the invention facilitates subsequent breaking, and minimizes production errors.

Further features, details and advantages of the invention can be found from the wording of the claims and from the following description of an embodiment with reference to the figure, in which:

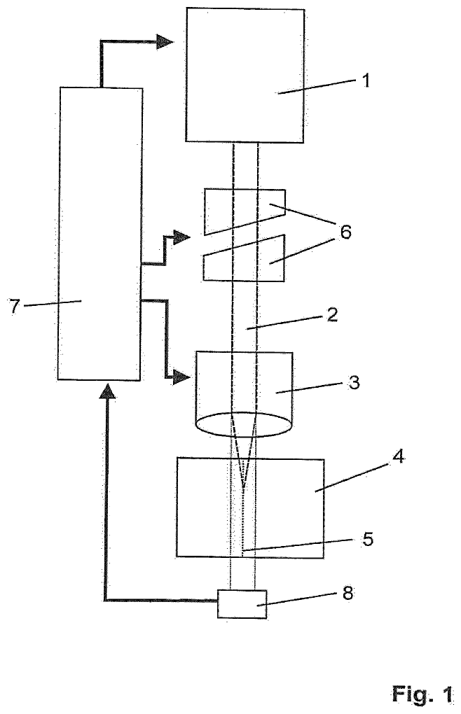

FIG. 1: is a schematic block diagram of a device according to the invention.

The device shown in FIG. 1 comprises a laser 1 that emits laser radiation 2. The laser 1 can be tuned with respect to the wavelength of the laser radiation. The laser radiation 2 is directed, by means of an objective 3, towards a workpiece 4.

The workpiece 4 consists for example of a special glass. This can for example be an optical filter glass. A separation plane 5 is intended to be introduced into the workpiece 4 by means of laser machining. The objective 3 focusses the laser radiation 2 such that the focus position inside the volume of the workpiece 4 is located on the separation plane 5. In this case, a controllable optical assembly 6 is provided, in order to vary the beam position in a plane perpendicular to the direction of the laser beam 2 (i.e. in the x- and y-direction). The objective 3 focusses the laser radiation 2 such that the focus position inside the volume of the workpiece 4 is located on the separation plane 5. In this case, a controllable optical assembly 6 is provided, in order to vary the beam position in a plane perpendicular to the direction of the laser beam 2 (i.e. in the x- and y-direction). The objective 3 and the assembly 6 together form a coupling optics that couples the laser beam 2 into the volume of the workpiece 4. The focal length of the objective 3 is also variably controllable. Overall, it is thus possible for the focus position to be varied in three dimensions, i.e. in the x-, y- and z-direction. In an alternative embodiment, it is possible to move the position of the workpiece 4 relative to the optics. The coupling optics is connected to a program-controlled controller 7. The program-controlled controller 7 actuates the objective 3 and the deflection device 6 in order to vary the focus position during the machining. In this case, the program-controlled controller 7 is designed to generate a specified modification profile within the workpiece 4 by means of non-linear absorption of the laser beam 2 in the focus, said profile specifically being along the separation plane 5. The program-controlled controller 7 also actuates the laser 1 in order to switch it on and off, respectively, generating the laser radiation. Furthermore, the device generating the laser radiation. Furthermore, the device comprises a photo detector 8′ as a measuring device, which photo detector is connected to the controller 7. The controller 7 can actuate the objective 3 such that the laser beam 2 is not focused inside the workpiece 4, but is instead transmitted through the workpiece 4. The transmitted laser beam 2 then strikes the photo detector 8. Varying the wavelength of the laser 1, by means of corresponding actuation using the controller 7, makes it possible to record a transmission curve of the workpiece 4, in order to carry out a spectral measurement of the linear absorption of the laser radiation in the material of the workpiece 4 prior to the actual machining, in a manner according to the invention. The controller 7 then adjusts the working wavelength of the laser 1, i.e. the wavelength to be used during the machining, in accordance with the measured transmission curve, to a value at which the linear absorption is less than 10% per centimeter, in the direction of the laser beam 2. For the purpose of spectroscopic measurement of the linear absorption, the laser 1 can be actuated so as to emit in a manner having reduced intensity, e.g. by reducing the power of a pump light source. In an alternative embodiment, the spectroscopic measurement is carried out ex situ, e.g. by means of a separate white light spectrometer. During the machining, the laser 1 then emits the laser beam 2 at a higher intensity, at which non-linear absorption, in particular ionization, occurs in the laser beam focus.

1. A method for machining a transparent workpiece by generating non-linear absorption of laser radiation in a laser beam focus located in a volume of the workpiece, the method comprising:
spectroscopic measurement of the linear absorption of the laser radiation in the workpiece using a laser that is tunable with respect to a wavelength of the laser radiation;
selecting a working wavelength at which the linear absorption is low; and
machining, using the laser, the workpiece by means of the application of laser radiation at the working wavelength.

2. The method of claim 1, wherein the working wavelength is selected in accordance with the stipulation that, at the working wavelength, the linear absorption in the laser beam direction is less than 20% per centimeter.

3. The method of claim 1, wherein the working wavelength is selected in accordance with the stipulation that, at the working wavelength, the linear absorption in the laser beam direction is less than 10% per centimeter.

4. The method of claim 1, wherein the transmission curve resulting from the measurement of the linear absorption exhibits a minimum at the working wavelength.

5. The method of claim 1, wherein during measurement of the workpiece, the intensity of the laser radiation remains below a threshold at which ionization processes occur in the volume of the workpiece.

6. The method of claim 1, wherein the laser radiation is pulsed, and the pulse duration of the laser pulse is from 10 fs to 100 ps.

7. The method of claim 1, wherein the working wavelength is selected in accordance with the secondary condition that the non-linear absorption should be as high as possible, at a harmonic of the working wavelength.

8. The method of claim 1, wherein machining the workpiece comprises separating glass workpieces.

9. The method of claim 8, wherein the position of the laser focus is guided, during the machining, between two or more connected glass workpieces, along a separation plane or a predetermined breaking point.

10. A device for machining a transparent workpiece, the device comprising
a laser that emits a laser beam at an adjustable working wavelength;
coupling optics that couples the laser beam into a volume of the workpiece and focusses the laser beam in a laser beam focus located in the volume of the workpiece;
a measuring device that measures a linear absorption of the laser radiation in the workpiece;
a controller coupled to the laser, the measuring device and the coupling optics, wherein the controller is designed to set the working wavelength to a value at which the linear absorption is low, and to vary the position of the laser beam focus during the machining of the workpiece.

11. The device of claim 10, wherein during the machining, the laser emits the laser beam at an intensity at which non-linear absorption, in particular ionization, occurs in the laser beam focus.
